(19) United States
(12) Patent Application Publication
(10) Pub. No.: US 2013/0268200 A1
(43) Pub. Date: Oct. 10, 2013

(54) SYSTEM AND METHOD TO PERFORM FORMATION IMAGING

(71) Applicant: Anton Nikitin, Houston, TX (US)

(72) Inventor: Anton Nikitin, Houston, TX (US)

(73) Assignee: BAKER HUGHES INCORPORATED, Houston, TX (US)

(21) Appl. No.: 13/442,162

(22) Filed: Apr. 9, 2012

(51) Int. Cl. G01V 5/04; G06F 19/00

(52) U.S. Cl. 702/8

(57) ABSTRACT

A downhole imaging system performs imaging in a borehole penetrating a formation. The system includes a source configured to emit gamma radiation toward an area of the borehole. The system also includes a first plurality of detectors configured to detect backscattered radiation originating from the source. Based on a distance between the source and each of the first plurality of detectors, detection by the first plurality of detectors provides a density image of the area of the borehole.

### BACKGROUND

Geologic formations may be used for various purposes such as hydrocarbon production, geothermal production, and carbon dioxide sequestration. An important aspect of ensuring efficient use of drilling resources includes characterizing the formation wall to ascertain, among other things, any structural defects, rugosity, cracks, and formation layer boundaries. In the past, electrical resistivity imaging has been employed. However, when conductivity is low due to high resistivity of a formation, there is not enough contrast to acquire a good image with this technique. Thus, a system and method to provide high resolution borehole images would be appreciated in the drilling industry.

### BRIEF SUMMARY

According to an aspect of the invention, a downhole imaging system to perform imaging in a borehole penetrating a formation includes a source configured to emit gamma radiation toward an area of the borehole; and a first plurality of detectors configured to detect backscattered radiation originating from the source, wherein, based on a distance between the source and each of the first plurality of detectors, detection by the first plurality of detectors provides a density image of the area of the borehole.

According to another aspect of the invention, a method to perform imaging in a borehole penetrating a formation includes disposing a source of gamma radiation on a surface of a collimator; and arranging a first plurality of detectors to detect backscattered gamma radiation originating from the source on a same surface of the collimator, wherein, based on a distance between the source and each of the first plurality of detectors, detection by the first plurality of detectors provides a density image of the area of the borehole.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of an apparatus including a gamma-gamma density imager;

FIG. 2 illustrates a cross-sectional view of another exemplary embodiment of an apparatus including a gamma-gamma density imager;

FIG. 3 depicts a cross-sectional view of an exemplary gamma ray device used to study the behavior of detected count rate with source-to-detector distance below 15 cm;

FIG. 4 depicts a cross-sectional view of a uniform formation geometry used in the modeling;

FIG. 5 depicts a cross-sectional view of a two-layer formation geometry used in the modeling;

FIG. 6 depicts a graph of formation density versus integrated f4 tallies (count rate CRₖ) for each of the ring detectors at the different radii (source-to-detector distances) SD;

FIG. 7 depicts a graph of formation density versus normalized integrated f4 tallies (count rate CRₖ) for each of the ring detectors at the different radii (source-to-detector distances) SD;

FIG. 8 depicts a graph of formation layer 2 thickness D versus integrated f4 tallies (count rate CRₖ) for each of the ring detectors at the different radii (source-to-detector distances) SD;

FIG. 9 depicts a graph of formation layer 2 thickness D versus normalized integrated f4 tallies (count rate CRₖ) for each of the ring detectors at the different radii (source-to-detector distances) SD;

FIG. 10 depicts an exemplary pad of a wireline gamma-gamma density imager according to an embodiment of the invention;

FIG. 11 depicts an exemplary pad of an LWD gamma-gamma density imager according to an embodiment of the invention;

FIG. 12 illustrates a cross-section of an exemplary detector of the gamma-gamma density imager according to an embodiment of the invention;

FIG. 13 depicts an exemplary arrangement of the detector of the embodiment of FIG. 12;

FIG. 14 shows an exemplary gamma-gamma density imager using a Geiger-Muller stack of detectors in an LWD tool according to an embodiment of the invention;

FIG. 15 illustrates a cross-section of another exemplary detector of the gamma-gamma density imager according to an embodiment of the invention;

FIGS. 16 and 17 illustrate different arrangements of yet another exemplary detector of the gamma-gamma density imager according to an embodiment of the invention; and

FIG. 18 depicts the processes involved in obtaining an image in a borehole environment.

### DETAILED DESCRIPTION

A detailed description of one or more embodiments of the disclosed apparatus and method presented herein by way of exemplification and not limitation with reference to the Figures.

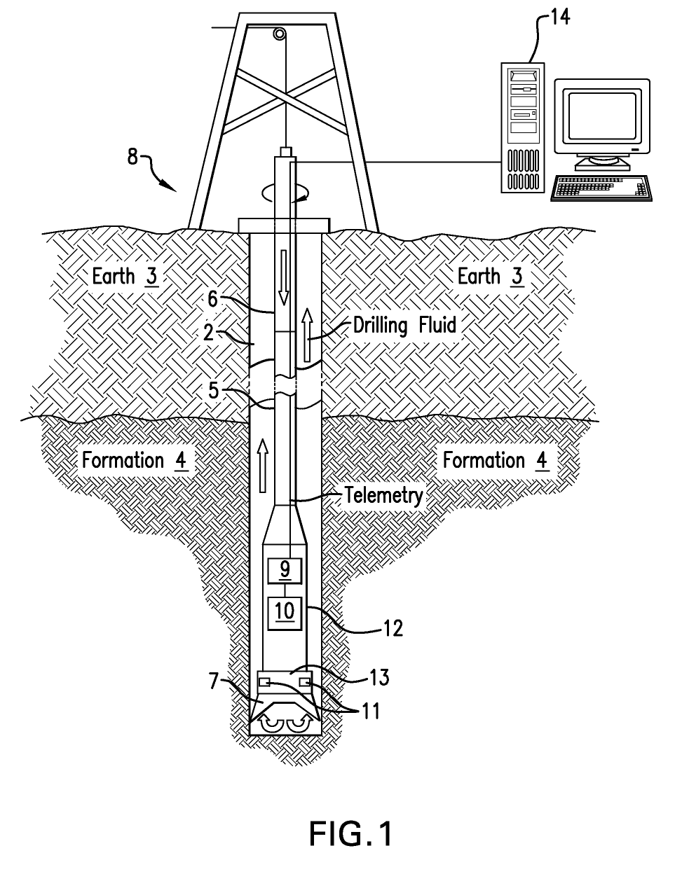

FIG. 1 illustrates a cross-sectional view of an exemplary embodiment of an apparatus including a gamma-gamma density imager 11. In the embodiment of FIG. 1, the carrier 5 is a drill string 6 in an embodiment known as logging-while-drilling (LWD). A bottomhole assembly 12 is disposed in a borehole 2 penetrating the earth 3, which includes an earth formation 4. The formation 4 represents any subsurface material of interest. The bottomhole assembly 12 is configured to perform one or more types of measurements and is conveyed through the borehole 2 by the drill string 6. Disposed at a distal end of the drill string 6 is a drill bit 7. As shown by FIG. 1, the gamma-gamma density imager 11 is disposed at an outer surface of a drill collar 13. In one embodiment, the gamma-gamma density imager 11 rotates with the drill bit 7. A drilling rig 8 is configured to conduct drilling operations such as rotating the drill string 6 and thus the drill bit 7 in order to drill the borehole 2. In one embodiment, the gamma-gamma density imager 11 is disposed such that it rotates with the drill bit 7. The drilling rig 8 is also configured to pump drilling fluid through the drill string 6 in order to lubricate the drill bit 7 and flush cuttings from the borehole 2. The bottomhole assembly 12 includes one or more measure while drilling (MWD) and logging while drilling (LWD) tools 10 for performing the measurements. Downhole electronics 9 may be configured to operate the bottomhole assembly 12, process data obtained by the MWD/LWD tools 10, and interface with telemetry (e.g., mud pulse telemetry) to communicate data to the computer processing system 14 at the surface of the earth 3.

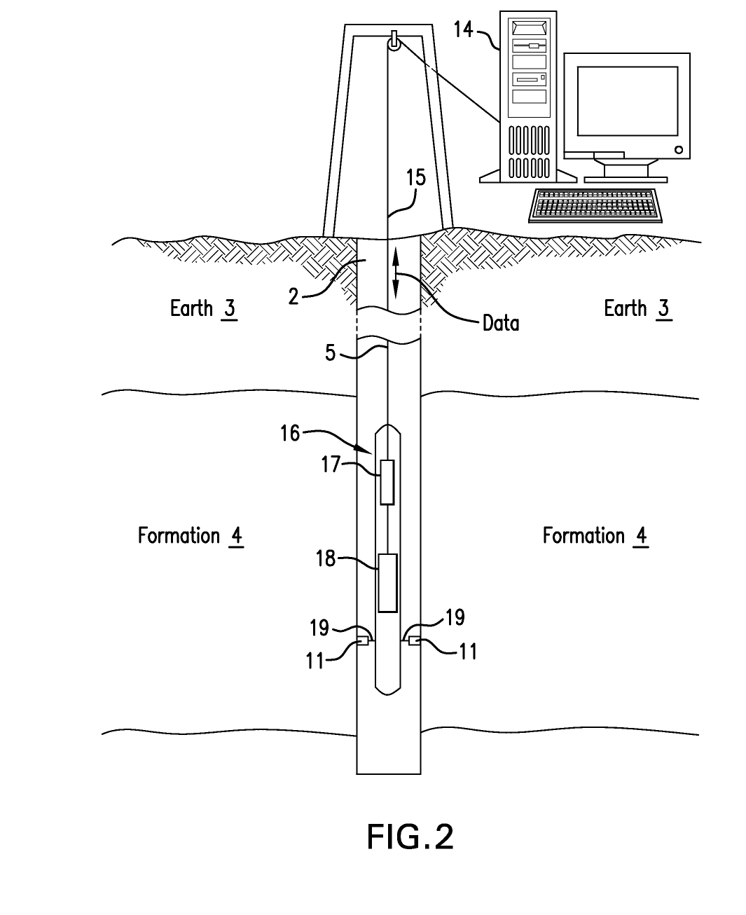

FIG. 2 illustrates a cross-sectional view of another exemplary embodiment of an apparatus including a gamma-gamma density imager 11. In the embodiment of FIG. 2, the carrier 5 is an armored wireline 15 used in wireline logging. A downhole tool 16 is disposed in the borehole 2 and is configured to perform one or more types of measurements. The downhole tool 16 includes one or more sensors and/or measurement tools 18 to perform the measurements. Downhole electronics 17 may be configured to operate the downhole tool 16, process data obtained by the sensors and/or measurement tools 18, and telemeter data to the computer processing system 14 at the surface of the earth 3. The gamma-gamma density imager 11, as shown in this embodiment, is extended via arms 19 to the borehole 2 wall from the downhole tool 16. Development of the gamma-gamma density imager 11 and its different embodiments are discussed below.

In a traditional gamma ray density well logging tool, two scintillation detectors, one a short spacing (SS) detector and the other a long spacing (LS) detector, are used. Typically, the two detectors are separated from the source by approximately 15 cm for the SS detector and approximately 40 cm for the LS detector. The large source-to-detector distances are chosen to maximize depth of investigation of the measurement. However, as a result, the LS detector must be relatively large (50 mm long) to be able to perform the measurement of the spectrum of gamma rays scattered by the formation with acceptable statistical precision at commercially viable signal accumulation times. In addition and more relevant to an imaging application, the arrangement of the gamma ray density well logging tool results in relatively low spatial resolution, which is defined by the source to detector distance. For example, if the count rate measured by the SS detector of the gamma ray density well logging tool were used to build a formation image, the resolution of the image would be approximately 15 cm (the same as the approximate distance between the SS detector and the source). This resolution provided by a traditional gamma ray density well logging tool is insufficient as an imaging device.

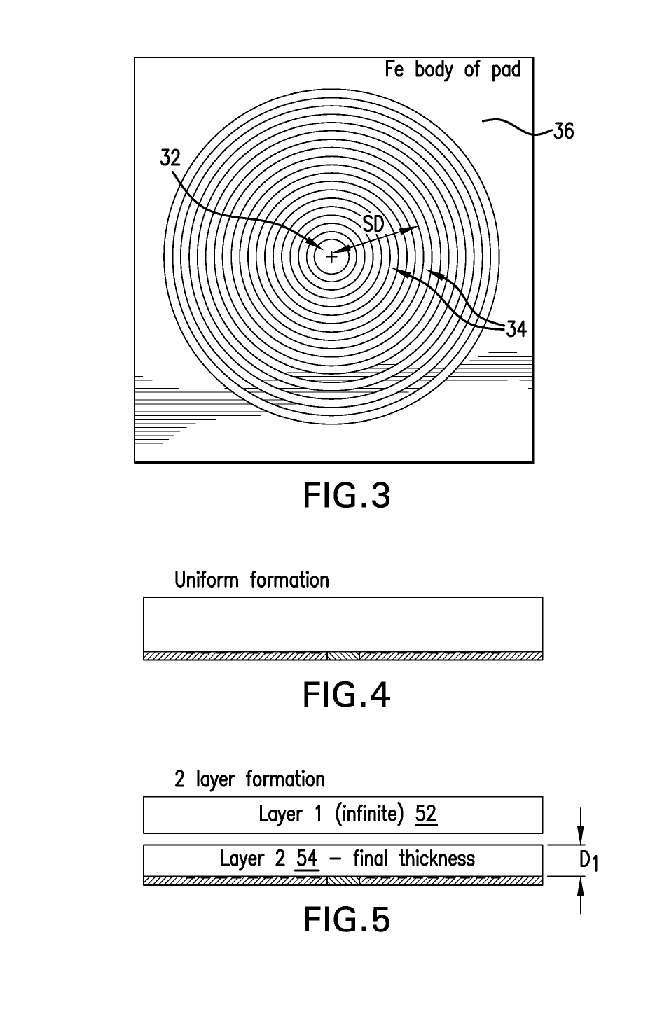

FIG. 3 depicts a cross-sectional view of an exemplary gamma ray device 30 used to model the behavior of detected count rate with source-to-detector distance below 15 cm. FIG. 4 depicts a cross-sectional view of a uniform formation geometry used in the modeling, and FIG. 5 depicts a cross-sectional view of a two-layer formation geometry used in the modeling. Monte Carlo N-Particle Transport Code System (MCNP5) modeling of gamma ray transport was performed. The f4 tallies (spectral distributions of fluxes) were calculated for gamma rays emitted by a point source 32 Cs¹³⁷ (photon energy, Eγ=662 KeV), scattered by a formation, and passing through ring detectors 34. FIG. 3 depicts the geometry of the gamma ray device 30 used for the modeling. The ring detectors 34 are arranged in concentric rings with a width of 1 cm and a thickness of 0.5 mm and are located in cutouts of the same shape at the surface of a pad 36 made of Fe. The gamma ray point source 32 is located at the surface of the Tungsten (W) collimator 38 in the center of the pad 36, and the pad 36 that contains the point source 32 and ring detectors 34 is in tight contact with the formation. Gamma ray flux passing through the ring detectors 34 was modeled for eight formations with different densities, detailed in Table 1 below, in the case of “uniform formation” geometry (FIG. 4). In the case of two-layer formation geometry (FIG. 5), layer 2 54 consists of 0 pu sandstone and layer 1 52 consists of water. The thickness D of layer 2 54 was varied in the modeling. The ring detectors 34 have radii ranging from 3.5 cm to over 15.5 cm. The configuration depicted by FIG. 3 has axial symmetry, and f4(E) tallies obtained from the different ring detectors 34 were integrated to obtain count rate (CR):

CRₖ=∫₀^{Eγ}f4ₖ(E)dE [EQ 1]

The values of count rate obtained from the different ring detectors 34 in the model were assumed to be proportional to the real count rate that would have been obtained from real detectors, and these values were used instead of count rates obtained using f8 (pulse height) tallies. This assumption is valid for scintillation or ionization detectors as first order approximation.

Table 1 details the eight different formations used to model the uniform formation geometry. The type of formation, density, and composition by weight are provided for each:

| | | Density | |
|---|---|---|---|
| # | Type | ρ, g/cc | Composition (wt parts) |
| 1 | Water | 1 | H: 0.1119; O: 0.4674 |
| 2 | 30 pu sandstone | 2.155 | H: 0.0156; O: 0.5821; Si: 0.4023 |
| 3 | 20 pu sandstone | 2.32 | H: 0.0095; O: 0.5627; Si: 0.4278 |
| 4 | 10 pu sandstone | 2.485 | H: 0.0021; O: 0.5467; Si: 0.4489 |
| 5 | 5 pu sandstone | 2.568 | H: 0.0021; O: 0.5394; Si: 0.4585 |
| 6 | 0 pu sandstone | 2.65 | O: 0.5326; Si: 0.4674 |
| 7 | 5 pu dolomite | 2.74 | H: 0.002; C: 0.12793; O: 0.51129; Mg: |
| | | | 0.12941; Ca: 0.21335 |
| 8 | 0 pu dolomite | 2.84 | C: 0.1303; O: 0.5206; Mg: 0.1318; Ca: |
| | | | 0.2173 |

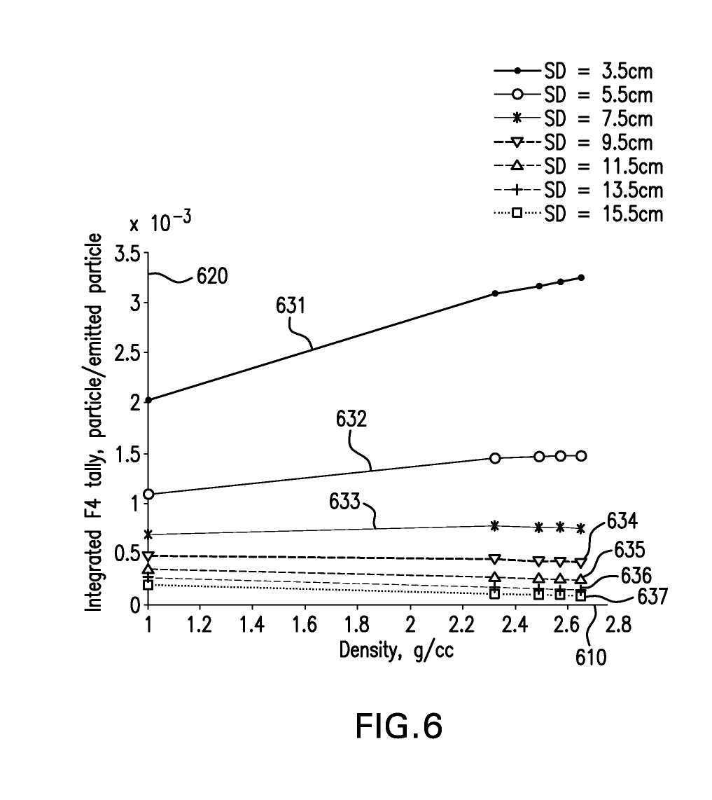

FIG. 6 depicts a graph of formation density on the x-axis 610 versus integrated f4 tallies (count rate CRₖ) according to EQ 1 on the y-axis 620 for each of the ring detectors 34 at the different radii (source-to-detector distances) SD. The modeling resulting in FIG. 6 uses uniform formation geometry as shown at FIG. 4. Lines 631-637 correspond with CRₖ results from ring detectors 34 at distances of 3.5 cm, 5.5 cm, 7.5 cm, 9.5, cm, 11.5 cm, 13.5 cm, and 15.5 cm, respectively, from the point source 32. As FIG. 6 illustrates, sensitivity of CRₖ to density increases as the radius SD of the ring detector 34 to the point source 32 decreases. That is, line 633 (SD=7.5 cm) has a CRₖ on the y-axis 620 that is almost flat with respect to density on the x-axis 610, indicating that the integrated f4 tallies (count rate CRₖ) are minimally dependent on the density of the formation. As distance to the point source 320 increases beyond SD=7.5 cm (e.g., line 637, SD=15.5 cm), sensitivity of the CRₖ value decreases as density of the formation increases. In the opposite direction, as the distance of the ring detector 340 to the point source 320 decreases (e.g., line 631, SD=3.5 cm), the sign of the line slope changes and dependence of CRₖ to an increase in density of the formation increases. This change in sign of the dependence of CRₖ is related to the increase of the contribution of backscattered gamma rays into the flux passing through the ring detectors 34 as the source-to-detector distance value decreases. It should be understood that, in gamma-gamma density measurements, the detected signal consists only of forward scattered gamma rays. This theoretically allows an increase in the depth of investigation. However, as FIG. 6 illustrates, it also limits spatial resolution of the measurements. In the case of “backscattering” gamma-gamma density measurement, when the source-to-detector distance is less than 5 cm, the spatial resolution is improved, as illustrated by FIG. 6. The results illustrated by FIG. 6 indicate that resolution of count rate for different formation densities increases as distance between the ring detector 34 and point source 32 decreases.

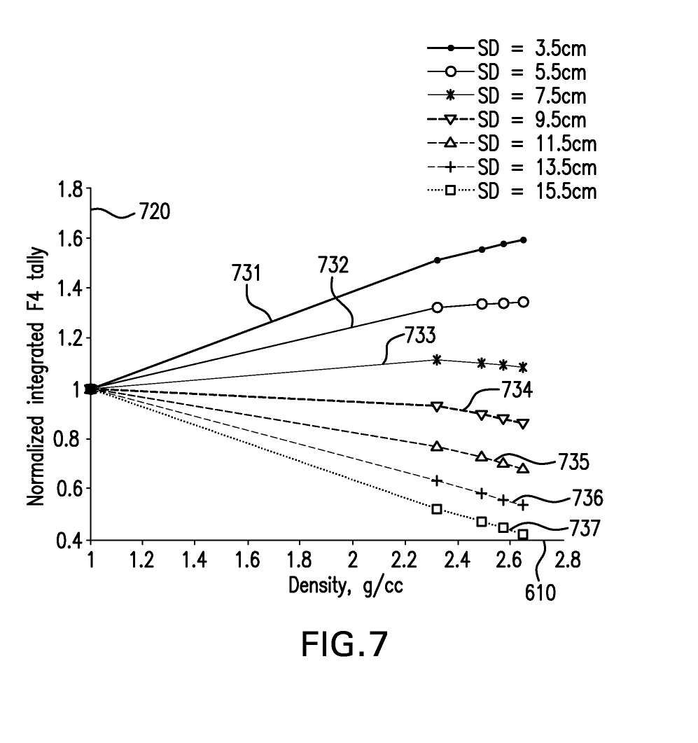

FIG. 7 depicts a graph of formation density on the x-axis 610 versus normalized integrated f4 tallies (count rate CRₖ) according to EQ 1 on the y-axis 720 for each of the ring detectors 34 at the different radii (source-to-detector distances) SD. For each ring detector k CRₖ, obtained for different formations, are normalized by CRₖ values obtained for water. Lines 731-737 correspond with normalized CRₖ results from ring detectors 34 at distances of 3.5 cm, 5.5 cm, 7.5 cm, 9.5, cm, 11.5 cm, 13.5 cm, and 15.5 cm, respectively, from the point source 32. As illustrated by lines 734-737 of FIG. 7, normalized CRₖ values decrease with an increase in (water) formation density ρ for ring detectors 34 with source-to-detector distances at or above SD=7.5 cm. However, normalized CRₖ values increase with increasing formation density ρ for ring detectors 34 with source-to-detector distances at or below SD=5.5 cm. As noted with respect to FIG. 6, lines 731-737 illustrate the increased spatial resolution in measurements obtained with lower source-to-detector distances.

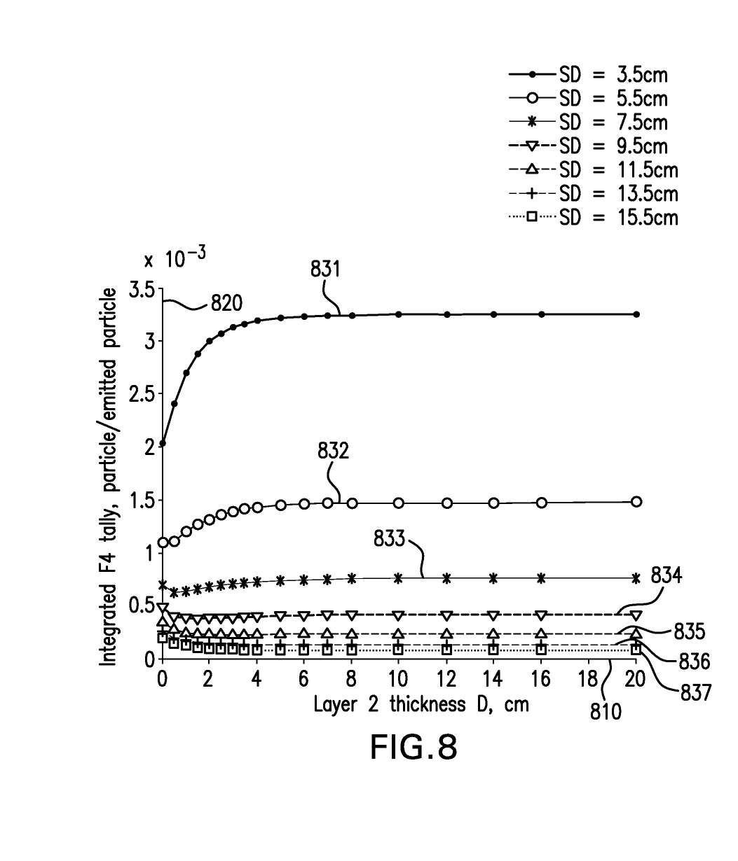

FIG. 8 depicts a graph of formation layer 2 54 thickness D on the x-axis 810 versus integrated f4 tallies (count rate CRₖ) according to EQ 1 on the y-axis 820 for each of the ring detectors 34 at the different radii (source-to-detector distances) SD.

The modeling resulting in FIG. 8 uses two-layer formation geometry as shown at FIG. 5 and, specifically, varies the thickness D of layer 2 54 (a 0 pu sandstone layer). Lines 831-837 correspond with CRₖ results from ring detectors 34 at distances of 3.5 cm, 5.5 cm, 7.5 cm, 9.5, cm, 11.5 cm, 13.5 cm, and 15.5 cm, respectively, from the point source 32. FIG. 8 shows that, for a measurement scheme (such as the one modeled) based on gamma ray backscattering, a decrease in source-to-detector distance results in a decrease in depth of investigation. This is illustrated by the fact that, in FIG. 8, line 831 corresponding to the shortest SD (source-to-detector distance of 3.5 cm), becomes constant for the lowest value of depth D among the lines shown. That is, CR dependence on depth D becomes constant at D=4 cm for an SD=3.5 cm while CR dependence on depth D becomes constant at D=7 cm for an SD=7.5 cm. While FIG. 8 indicates that a smaller source-to-detector distance (SD) would be disadvantageous in depth of investigation of density of a formation,

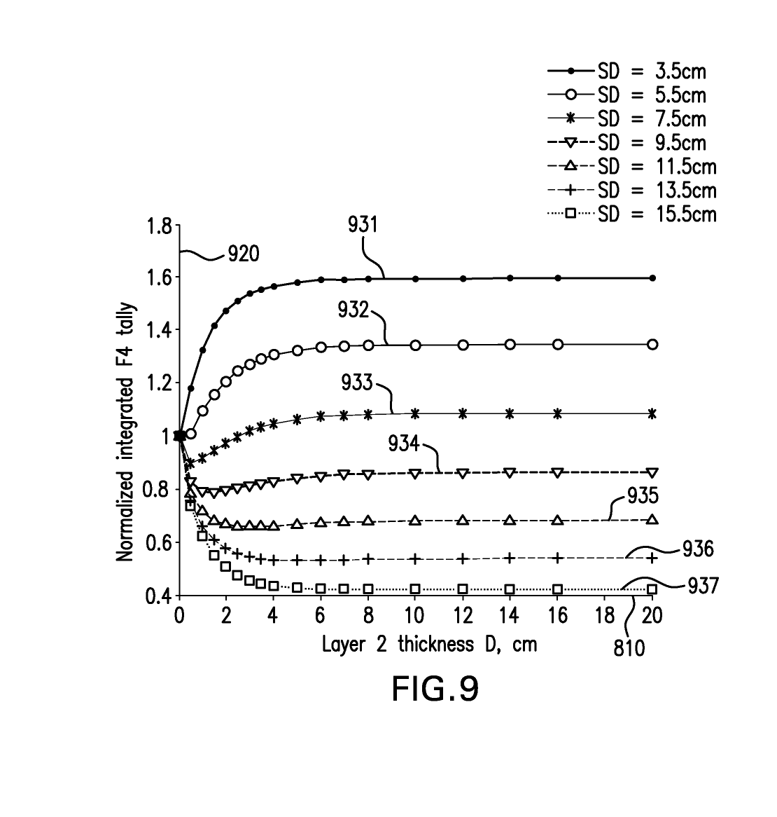

FIG. 9 depicts a graph of formation layer 2 54 thickness D on the x-axis 810 versus normalized integrated f4 tallies (count rate CRₖ) according to EQ 1 on the y-axis 920 for each of the ring detectors 34 at the different radii (source-to-detector distances) SD. The modeling resulting in FIG. 9 varies the thickness D of layer 2 54 (a water layer). Lines 931-937 correspond with normalized CRₖ results from ring detectors 34 at distances of 3.5 cm, 5.5 cm, 7.5 cm, 9.5, cm, 11.5 cm, 13.5 cm, and 15.5 cm, respectively, from the point source 32. As noted with respect to FIG. 8, lines 931-937 indicate the decreased depth of investigation that is possible with the gamma ray backscattering measurement scheme modeled using the ring detectors 34.

FIGS. 6-9 indicate that a smaller source-to-detector distance (SD) may prove disadvantageous in depth of investigation of density of a formation. However, the figures also indicate that, because spatial resolution is increased as SD values are decreased, small gamma ray counters located close (e.g., 1-2 cm) to a Cs¹³⁷ gamma ray source would allow imaging of a formation by detecting gamma rays backscattered by the formation. Further, the figures also indicate that the imaging is not dependent on the electrical properties of the mud used in drilling and is an effective imaging technique regardless of the mud used. That is, the modeling discussed above indicates that decreasing source-to-detector distance increases lateral resolution with respect to a borehole wall for the purposes of imaging rather than aiding depth of investigation. The contrast of the image would be defined by the relative variation of the formation density and the spatial resolution would be proportional to SD (1-2 cm).

Also, the addition of a second detector located farther from the gamma ray source would allow the measurement of the absolute variation of the formation density, as well. When two detectors are used, the formation density can be defined from the equation:

f(ρ)=CR₁/CR₂ [EQ 2]

where CR₁ and CR₂ are the count rates detected by the two detectors, and
f(ρ) is a function whose particular form is defined by the design of the pad implementing the measurement scheme. As discussed above with respect to any wireline or LWD tools, the gamma detectors may send output to the downhole electronics 9 and/or telemeter data to the computer processing system 14 in order to generate the image and (with the second detector) provide the quantitative density value.

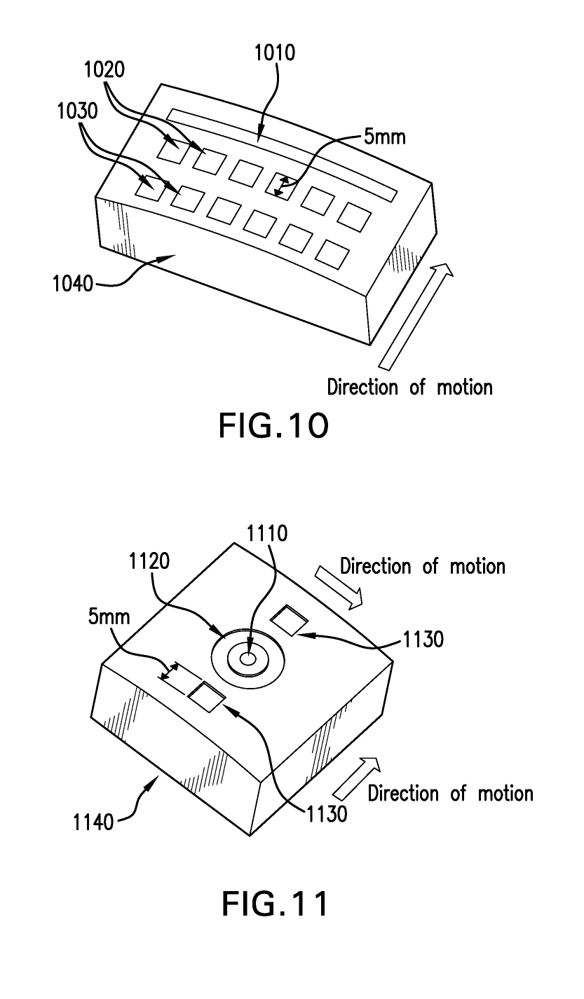

FIGS. 10 and 11 depict exemplary pads of a wireline imager and an LWD imager, respectively, implementing a gamma-gamma density imager 11 according to an embodiment of the invention. As shown in the embodiment of FIG. 10, the wireline imager pad 1000 includes a linear Cs¹³⁷ source 1010 and two parallel rows of gamma ray detectors (counters) 1020, 1030. In one exemplary embodiment, the collimator 1040 including the pad 1000 is a tungsten (W) collimator 1040. In one embodiment, the two rows of gamma ray detectors 1020, 1030 are separated by 1-2 cm, and each gamma ray detector 1020, 1030 has a width of 5 mm on the surface of the pad 1000. In a preferred embodiment, the pad 1000 of the gamma-gamma density imager 11 of the embodiment shown by FIG. 10 is arranged so that, as the wireline 15 lowers the downhole tool 16, the linear source 1010 enters the borehole first (the source 1010 is at the bottom of the pad 1000 as the downhole tool 16 is lowered). Based on this arrangement, the gamma-gamma density imager 11 including the pad 1000 of the embodiment of FIG. 10 can obtain formation 4 images as it is lowered. By additionally including the gamma ray detectors 1030, the gamma-gamma density imager 11 of the present embodiment is also able to obtain density values for the formation 4 in a similar manner to a traditional gamma ray density well logging tool with SS and LS detectors as described above. An embodiment of the gamma-gamma density imager 11 may include 4-8 of pad 1000 arrangements. Alternate embodiments may include an overlap in the coverage of each of the pads 1000 and the pads 1000 may be disposed at different angles around the downhole tool 16 to provide images for the full circumference of the borehole wall. In theory, a single source 1010 and detector 1020 are capable of providing a borehole 2 wall image. However, in this embodiment and other embodiments of the gamma-gamma density imager 11, by increasing the number of detectors 1020, measurement (imaging) speed can be increased such that the borehole tool 16 can be moved more quickly without compromising the resolution of the obtained image.

As shown in the embodiment of FIG. 11, the LWD imager pad 1100 includes a Cs¹³⁷ source 1110, an inner detector 1120, and outer detectors 1120. As shown in the embodiment of FIG. 11, the source 1110 may be disposed at the center of the pad 1100. In one embodiment, the collimator 1140 including the pad 1100 is a tungsten (W) collimator 1140. In alternate embodiments, the LWD imager pad 1100 may be disposed on the outer surface of the drill bit 7 such that the pad 1100 is rotating with the drill bit 7. In one embodiment, the inner detector 1120 has a circular shape surrounding the source 1110 such that a full 360 degree image of the borehole wall is obtained. In an embodiment with the circular inner detector 1120 on the surface of the drill bit 7, a full image of the borehole wall may be obtained as the drill bit 7 penetrates the formation 4 to form the borehole 2. It should be understood that the rate of drill bit penetration must be coordinated with rotation of the part of the bottomhole assembly 12 where the gamma-gamma density imager 11 is disposed to minimize areas of the borehole wall that are not imaged.

The detectors 1020, 1030, 1120, 1130 may be implemented in a number of ways. It should be understood that any detectors that can be formed sufficiently small for the borehole 2 environment and can withstand the high temperatures of a downhole drilling environment are suitable as the detectors 1020, 1030, 1120, 1130 discussed above. Three exemplary detector embodiments are discussed herein.

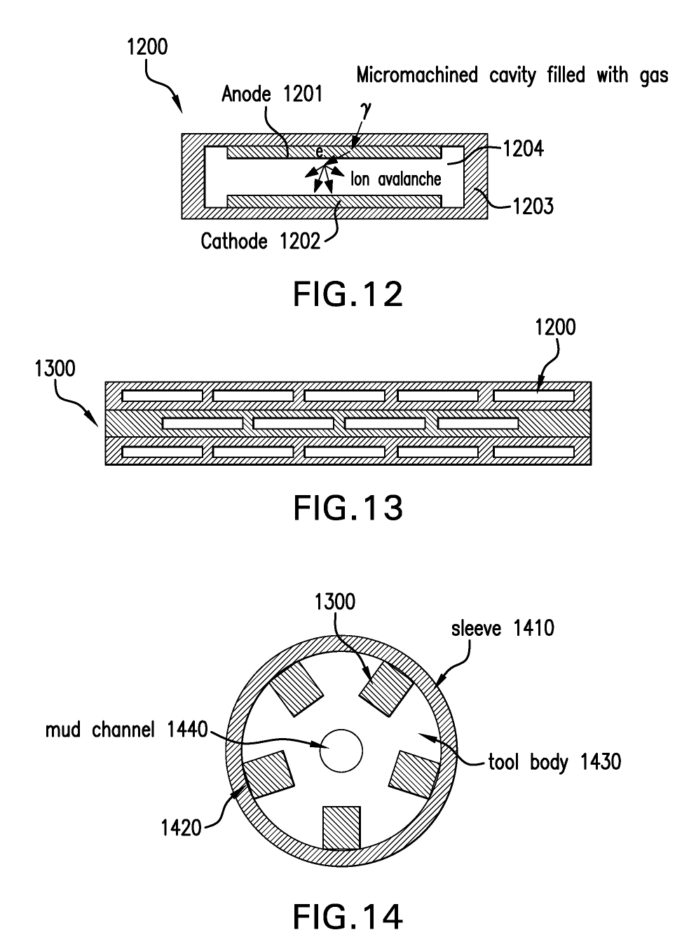

FIG. 12 illustrates a cross-section of an exemplary detector 1200 of the gamma-gamma density imager 11 according to an embodiment of the invention. The detector 1200 includes parallel plates 1201 (anode) and 1202 (cathode) with a gap between the plates 1201, 1202 filled with inert gas. Unlike a traditional Geiger-Muller tube configuration, the “flat” configuration shown by FIG. 12 operates at lower voltages. This is possible because, based on the relatively smaller distance between the electrode plates 1201, 1202 (compared with a traditional tube), the electric filed strength value required to obtain avalanche discharge in the gas caused by electrons emitted from the electrode plates 1201, 1202 is lower. In exemplary embodiments, the plates 1201, 1202 may be made of refractory metals such as Platinum (Pt), Tantalum (Ta), and Tungsten (W). These metals have relatively higher density, which increase detection efficiency due to their higher gamma ray adsorption coefficient. In one embodiment, the gap between the plates 1201, 1202 is on the order of 100 micro meters. The cavity 1203 is filled with gas 1204. The overall thickness of the cavity may be on the order of 1 mm. Generally, the gas is a low-pressure inert gas such as helium, argon, or, usually, neon. In one embodiment, micromachining technology is used to produce the detector 1200 in order to ensure that the plates 1201, 1202 are aligned with each other and to increase the efficiency of the detector 1200.

FIG. 13 depicts an exemplary arrangement of the detector 1200 of the embodiment of FIG. 12. The stack 1300 of detectors 1200 increases overall detection efficiency. In a basic sense, efficiency of gamma ray detection is a function of thickness and density of the cavity 1203. The stack 1300 arrangement creates a set of detectors 1200 with increased thickness (and, thus, increased efficiency) when compared with a single detector 1200. The efficiency of the stack may be defined by:

$${α}_{st} = {α}_{sc} \cdot \frac{exp ( - ( n + 1 ) d / {d}_{γ} ) - 1}{exp ( - d / {d}_{γ} ) - 1} \qquad [ EQ 2 ]$$

where αₛₜ=efficiency of the stack 1300;
α_{sc}=efficiency of a single cavity 1203;
n=number of cavities 1203 in the stack 1300;
d=integral wall thickness of the cavity 1203;
d_{γ}=gamma ray attenuation length for the cavity 1203 material (Silicon)
While the efficiency of a traditional Geiger-Muller tube configuration counter is on the order of 1 to 3%, the stack 1300 can have gamma ray detection efficiency on the order of 10% when the overall thickness of the stack 1300 is approximately 25 mm. Further, the detector 1200 (alone or arranged in the stack 1300) is capable of operation at temperatures in the 200 to 300 degree Celsius range. In alternate embodiments, the stack 1300 arrangement of Geiger-Muller detectors 1200 may be used in a wireline arrangement or LWD scenario. FIG. 14 shows an exemplary gamma-gamma density imager 11 using a Geiger-Muller stack 1300 of detectors 1200 in an LWD tool according to an embodiment of the invention. As shown, a circular sleeve 1410 holds multiple pockets 1420 of Geiger-Muller detector 1200 stacks 1300. In the embodiment shown by FIG. 14, the tool body 1430 enclosed by the sleeve 1410 includes a mud channel 1440 at the center for lubricating mud needed in the drilling process.

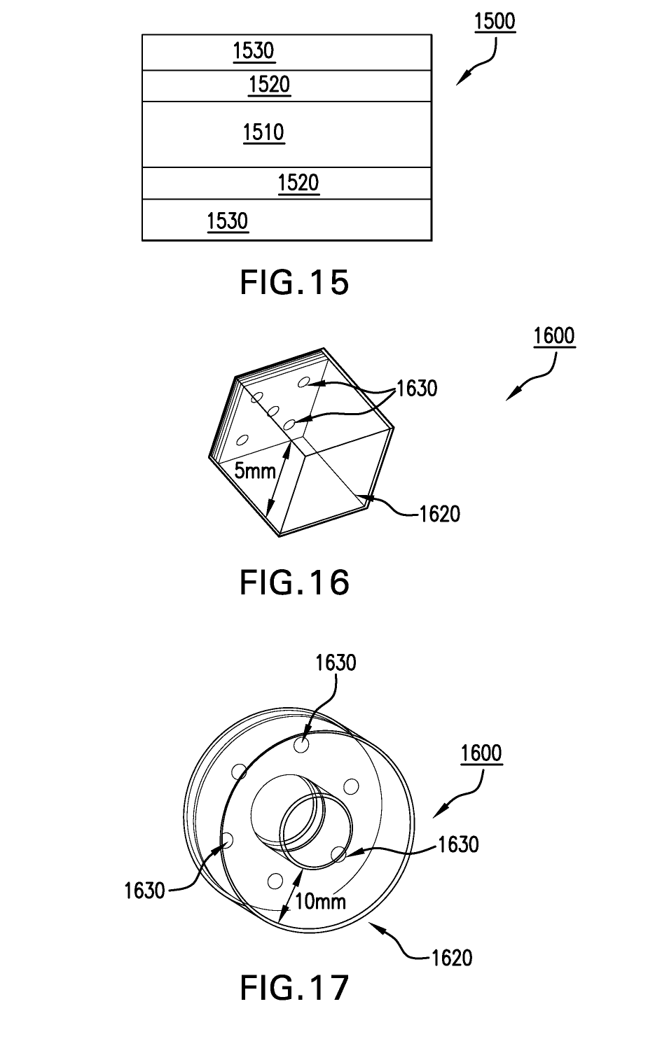

FIG. 15 illustrates a cross-section of another exemplary detector 1500 of the gamma-gamma density imager 11 according to an embodiment of the invention. Specifically, the detector 1500 is a diamond radiation detector whose operational details are set out in A. Galbiati, S. Lynn, K. Oliver, F. Schirru, T. Nowak, B. Marczewska, J. A. Dueñas, R. Berjillos, I. Martel, L. Lavergne “Performance of Monocrystalline Diamond Radiation Detectors Fabricated Using TiW, Cr/Au and a Novel Ohmic DLC/Pt/Au Electrical Contact” IEEE TRANSACTIONS ON NUCLEAR SCIENCE, VOL. 56, NO. 4, AUGUST 2009, 1863-1874. The detector 1500 in the embodiment of FIG. 15 includes a diamond layer 1510 sandwiched by contacts comprising a diamond-like carbon (DLC) layer 1520 and a noble metal 1530. In alternate embodiments, the noble metal 1530 layer may include platinum (Pt) or gold (Au). The DLC layer 1520 may be formed by depositing carbon on a diamond substrate as detailed in the Galbiati, et al. paper. In alternate embodiments, the detector 1500 may be arranged in an array or formed in a stack, as described for the Geiger-Muller stack 1300, to increase efficiency.

FIGS. 16 and 17 illustrate different arrangements of yet another exemplary detector 1600 of the gamma-gamma density imager 11 according to an embodiment of the invention. The detector 1600 includes a yttrium aluminum perovskite doped with praseodymium (YAP:Pr) scintillation crystal 1620 and silicon carbide (SiC) avalanche photodiodes (APDs) 1630. The embodiment shown by FIG. 16 includes the YAP:Pr scintillation crystal 1620 in a cube-like shape with APDs 1630 on one surface. The dimension of YAP:Pr scintillation crystal 1620 may be on the order of 5 mm. The number and arrangement of APDs 1630 of the detector 1600 may be selected to ensure sufficient coverage and count rate of the gamma-gamma density imager 11. The embodiment of FIG. 16 may be well-suited for a wireline application, and multiple gamma-gamma density imagers 11 of detectors 1600 may be arranged to extend by arms 19 from the downhole tool 16. The embodiment of FIG. 17 may be well-suited for an LWD application and can fit into a bottomhole assembly 12 for use while drilling.

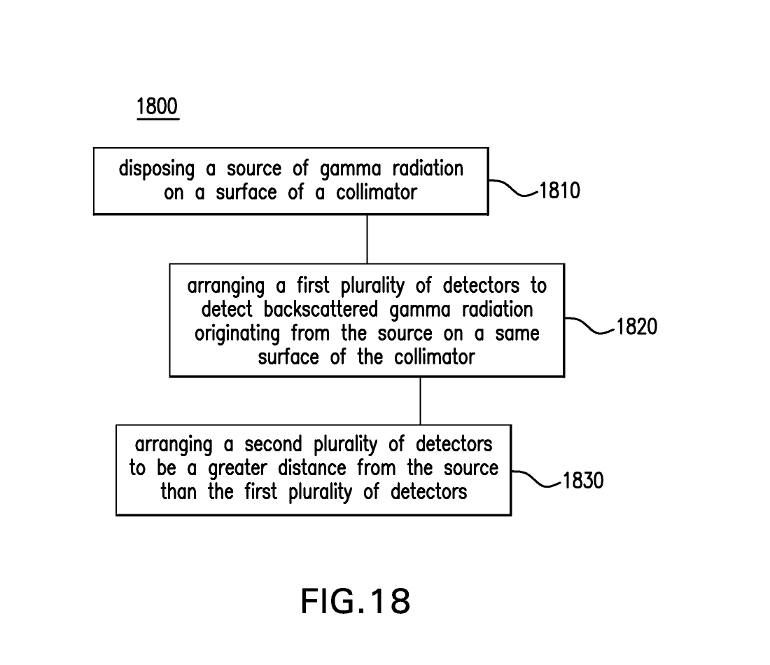

FIG. 18 depicts the processes 1800 involved in obtaining an image in a borehole 2 environment. At 1810, the processes 1800 include disposing a source 32 of gamma radiation on a surface of a collimator 38 such as a tungsten (W) collimator. At 1820, arranging a first plurality of detectors 34 to detect backscattered gamma radiation originating from the source 32 on a same surface of the collimator 38 includes the different arrangements and embodiments discussed above. The processes 1800 can additionally include arranging a second plurality of detectors 34 to be a greater distance from the source 32 than the first plurality of detectors 34 at 1830. The second plurality of detectors 34 would allow a determination of quantitative density of the formation as discussed above.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order. The term “couple” relates to coupling a first component to a second component either directly or indirectly through an intermediate component.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A downhole imaging system to perform imaging in a borehole penetrating a formation, the system comprising:
a source configured to emit gamma radiation toward an area of the borehole; and
a first plurality of detectors configured to detect backscattered radiation originating from the source, wherein, based on a distance between the source and each of the first plurality of detectors, detection by the first plurality of detectors provides a density image of the area of the borehole.

2. The system according to claim 1, wherein the source is a linear cesium (Cs¹³⁷) source and the first plurality of detectors is arranged in a first row with each detector of the first plurality of detectors being equidistant from the source.

3. The system according to claim 2, further comprising a second plurality of detectors arranged in a second row with each detector of the second plurality of detectors being equidistant from the source, wherein detection by the first plurality of detectors and the second plurality of detectors is used to determine quantitative density values of the area of the borehole, and the first row is closer to the source than the second row.

4. The system according to claim 2, wherein the system is part of a downhole tool lowered into the borehole by a carrier after drilling of the borehole has ceased and is extended from the downhole tool toward the borehole wall by an extension arm.

5. The system according to claim 4, wherein the carrier is a wireline.

6. The system according to claim 4, wherein each of the first plurality of detectors is a stack of Geiger-Muller gamma ray counters, each of the Geiger-Muller gamma ray counters in the stack being formed as a micromachined cavity filled with gas and with electrodes deposited at opposite surfaces of the micromachined cavity.

7. The system according to claim 6, wherein the gas one of helium, argon, or neon.

8. The system according to claim 4, wherein each of the first plurality of detectors is a diamond radiation detector comprising a diamond layer sandwiched between layers of metal forming electrodes.

9. The system according to claim 4, wherein each of the first plurality of detectors comprises a yttrium aluminum perovskite doped with praseodymium (YAP:Pr) scintillation crystal with a plate comprising silicon carbide (SiC) avalanche photodiodes (APDs) on a surface of the crystal.

10. The system according to claim 9, wherein each of the first plurality of detectors is formed as a rectangular object.

11. The system according to claim 1, wherein the source is a cesium (Cs¹³⁷) point source, and the first plurality of detectors is formed as a ring surrounding the source.

12. The system according to claim 11, further comprising a second plurality of detectors arranged symmetrically with respect to and equidistant from the source, wherein detection by the first plurality of detectors and the second plurality of detectors is used to determine density values of the area of the borehole, and the first row is closer to the source than the second row.

13. The system according to claim 11, wherein the system is part of a bottomhole assembly.

14. The system according to claim 13, wherein the system is disposed on an outer surface of a drill penetrating the formation to form the borehole and rotates with the drill rotation.

15. The system according to claim 13, wherein each of the first plurality of detectors is a diamond radiation detector comprising a diamond layer sandwiched between layers of metal.

16. The system according to claim 13, wherein each of the first plurality of detectors in the ring is formed as a stack of Geiger-Muller gamma ray counters, each of the Geiger-Muller gamma ray counters in the stack being formed as a micromachined cavity filled with gas and with electrodes deposited at opposite surfaces of the micromachined cavity.

17. The system according to claim 13, wherein the first plurality of detectors is formed as a ring formed of yttrium aluminum perovskite doped with praseodymium (YAP:Pr) scintillation crystal with a plate comprising silicon carbide (SiC) avalanche photodiodes (APDs) on a surface of the crystal.

18. A method to perform imaging in a borehole penetrating a formation, the method comprising:
disposing a source of gamma radiation on a surface of a collimator; and
arranging a first plurality of detectors to detect backscattered gamma radiation originating from the source on a same surface of the collimator, wherein, based on a distance between the source and each of the first plurality of detectors, detection by the first plurality of detectors provides a density image of the area of the borehole.

19. The method according to claim 18, wherein the method is performed during drilling or when drilling has ceased.

20. The method according to claim 18, further comprising arranging a second plurality of detectors to be a greater distance from the source than the first plurality of detectors, wherein detection by the first plurality of detectors and the second plurality of detectors is used to determine quantitative density values of the area of the borehole.
